(19) United States
(12) Patent Application Publication
(10) Pub. No.: US 2017/0075736 A1
(43) Pub. Date: Mar. 16, 2017

(54) RULE ENGINE FOR APPLICATION SERVERS

(71) Applicant: NOKIA SOLUTIONS AND NETWORKS OY, Espoo (FI)

(72) Inventors: Nuno Alexandre BORGES, Amadora (PT); Andre Goncalo FIGUEIRA, Aldeia de Paio Pires (PT); Ivo RODRIGUES, Rana (PT); Joao MARTINS, Carnaxide (PT); Joao SILVA TEIXEIRA, Almada (PT); Nuno MEIRA, Queluz (PT); Sergio Afonso ABREAU, Póvoa de Santa Iria (PT); Vasco CARVALHO, Odivelas (PT); Luis MARREIROS, Amadora (PT); Rui Pedro ALVES DA CUNHA, Charneca de Caparica (PT)

(21) Appl. No.: 15/124,307

(22) PCT Filed: Mar. 7, 2014
(86) PCT No.: PCT/EP2014/054462

§ 371 Date: Sep. 7, 2016

(51) Int. Cl. G06F 9/54; G06F 9/50

(52) U.S. Cl. CPC G06F 9/542; G06F 9/5033

(57) ABSTRACT

A node managing unit (11) selects, for an event associated with a sub-context of a specific context, an event distributing unit of a plurality of event distributing units (12, 13), which distributes events towards queues for the specific context. The selected event distributing unit selects a queue for the sub-context, which is associated with a rule engine unit of a plurality of rule engines units (17, 19), which comprises a rule execution unit associated with the specific context. A rule managing unit of the rule engine unit, which receives the event from the selected queue for the sub-context, selects the rule execution unit of the plurality of rule execution units, which is associated with the specific context, and delivers, to the selected rule execution unit, a particular rule of a rule set associated with the rule execution unit, within the associated sub-context.

### BACKGROUND OF THE INVENTION

Field of the Invention

The present invention relates to a rule engine for application servers.

Related Background Art

The following meanings for the abbreviations used in this specification apply:

API application programming interface

BE backend

DB database

JDK Java development kit

JS JavaScript

JVM Java virtual machine

PoC proof of concept

SQM service quality manager

Rule engines are known from the prior art, which run known rules for sets of facts with regard to different perspectives. That is, the known rule engines may be production or reaction type engines, forward or backward chaining engines, engines focusing on performance, scalability, etc. Some of the known engines are all-rounder engines, while others focus on specific characteristics.

### SUMMARY OF THE INVENTION

The present invention aims at providing a rule engine that is clustered, scalable, comprises runtime rule management and a simple/generalized knowledge rule language, runs on server side, ensures the chronological order of dependent events, limits rule execution runtime access to specific resources, and provides business logics flexibility within each rule.

This is achieved, at least in part, by a rule engine unit, an apparatus, a method and a computer program product as defined in the present disclosure.

According to an embodiment of the invention, a clustered rule engine apparatus is provided. In known rule engine systems, which use a non-clustered single threaded rule engine, a lot of workarounds may have to be used each time the maximum processing capacity of a hosting machine is reached, and the single thread behavior may impose latencies on rule executions. These problems can be mitigated or even eliminated by the clustered rule engine apparatus of the invention.

According to an embodiment of the invention, a clustered rule engine apparatus is provided that is scalable horizontally, enabling accommodation of new nodes on the cluster. Addition of new nodes does not force complete engine restart and does not result in loss of incoming events.

According to an embodiment of the invention, a rule engine unit is provided that enables addition or removal of rules to/from the rule engine unit without forcing complete engine restart and without loss of incoming events. The rule engine unit provides a possibility of editing existing rules and applying the changes without the need to compile or deploy any files.

According to an embodiment of the invention, a rule engine unit is provided that enables construction of rules using a widespread non-proprietary language. A minimal set of syntax is required, and loop control and variable manipulation are enabled.

According to an embodiment of the invention, a rule engine unit is provided that runs on server side where events to be processed are arriving. Rule results are seamlessly available for any presentation client.

According to an embodiment of the invention, a clustered rule engine apparatus is provided that preserves consecutiveness for chronologically dependent events and at the same time ensures a high level of parallelization based on independent events. Hence, reliable results can be obtained while meeting required performance and consistency levels.

According to an embodiment of the invention, a rule engine unit is provided that ensures control over resources accessed by rule executions while using a generalized programming language.

According to an embodiment of the invention, a rule engine unit is provided that uses a rules language allowing a rich set of syntax elements for advanced complex use cases, as well as a way to access external resources implementing more complex logics.

In the following the invention will be described by way of embodiments thereof with reference to the accompanying drawings.

### BRIEF DESCRIPTION OF THE DRAWINGS

FIG. 1 shows a schematic block diagram illustrating an overall design of a rule engine apparatus according to an embodiment of the invention.

FIG. 2 shows a schematic block diagram illustrating a configuration of a rule engine unit according to an embodiment of the invention.

FIG. 3 shows a flowchart illustrating a process 1 according to an embodiment of the invention.

FIG. 4 shows a schematic block diagram illustrating a configuration of a control unit in which examples of embodiments of the invention are implementable.

### DESCRIPTION OF THE EMBODIMENTS

According to an embodiment of the invention, a rule engine unit is proposed that is based on an open source JavaScript (JS) engine—Rhino—surrounded by a messaging infrastructure to potentiate parallelism and scalability. The JS engine (rule execution unit) can run in backend JDK environment and allows writing the rule logics in JavaScript, loading them into the JS engine and executing them on request of other components, thus enabling the rule engine unit to run on server side.

JavaScript is a well known language used extensively in web application development, which makes its knowledge base quite large. The fact that this language has been around for a long time and is used by a large community also makes it well proven and very reliable. Being a scripting language also allows for a simplified programming experience by new corners. These features make it a good choice for rule logic definition and enables the rule engine unit to use simple/generalized knowledge rule language.

JavaScript also has the advantage that it does not require compiling and that it allows the deployment of new rules immediately after their creation and keeps their original code persisted for editing or restoring at any point in time. No intermediate steps are required between a user defining a rule and the rule becoming deployed to the rule engine unit. Rules are JavaScript snippets, which are built as JavaScript functions and added to the rule engine unit, which allows each function to be called later on, resulting in a rule execution. Each function can be requested to execute with the correspondent parameters which include the trigger event(s) and additional resources required by the event processing (e.g. objects to allow the rule to persist results). The deletion (or removal) of rules however is not easy, as JS code added to the rule engine unit cannot be removed (either partially or totally). To overcome that problem, according to an embodiment of the present invention, a new rule engine unit is built and once it becomes available the previous one is destroyed, thus avoiding down time and ensuring run time management capabilities.

Adding all the user rules to the same rule engine unit will eventually lead to an increase of the overhead associated with executing a specific rule, as well as eventually exhausting allocated resources. According to an embodiment of the invention, rules are grouped per context and only related rules are kept in a specific rule set of a rule execution unit (e.g. JS engine). This is possible because rules are typically created in the context of specific entities (e.g. house rules, school rules, road rules, etc.) and these rules are not required to share information between them as their facts are fully independent between each other, so multiple engine cores (rule execution units, e.g. JS engines) are instanced, each instance specialized in specific rule sets with rules that potentiate parallelism of rule execution; this arrangement addresses the issue of scalability.

Keeping all the rule engine units within a single node (machine) eventually keeps their response times acceptable, but at a certain point the limit of available resources will be reached. To overcome this problem, according to an embodiment of the invention, a clustered rule engine apparatus is provided, which can distribute the load through multiple nodes (machines) holding the rule engine functionalities. In the clustered rule engine apparatus, JS engines (rule execution units) are created in multiple nodes and all the nodes hold all the rules (JS engines). According to an embodiment of the invention, the clustered rule engine apparatus comprises a node manager (NM, node managing unit) which allocates node responsibilities throughout the multiple existing JS engines. The NM specifies which node will compute events for each contextualized engine (e.g. house rules in node 1, school rules in node 2, etc.), creating the clustered rule engine apparatus. The allocation is dynamically managed and changed in runtime according to the nodes (machines) registered in the node manager. This approach allows the overall engine infrastructure to distribute the load across a cluster of resources.

The distribution of events by contextualized JS engines also helps to maintain the chronological order of dependent events. Dependent events need to be processed in the correct order within a specific context, but not across different contexts. An example is a phone call from school to house. It is the same event, but it may break school rules and not house rules. Nevertheless, if the call is initiated and terminated between the end and start of a lesson period, it does not break the school rules. It is important that the order of events is kept for the school rules, but for the house rules it does not matter. Accordingly, events for the same JS engine are processed sequentially, which ensures the chronological order of dependent events.

When the JS code is executed in a BE server, for controlling the access of the rules to BE services/resources, according to an embodiment of the invention an infrastructure (rule API, interface unit) is provided that can be used within the rules to access BE resources seamlessly. The API implementation creates wrappers for each of the relevant services/resources and ensures that a certain rule (JS engine) only accesses the resources it is authorized to and follows a predefined protocol such that the user is not required to know when he is implementing the rules. For example, when a user needs to persist a result, he does not need to know how to persist the value down to a persisting unit in use (e.g. a DB), but rather only invoke the API methods with the required parameters (e.g. key, value pair). Thus, accessible resources can be limited and the access to lower level and complex operations can be simplified, while at the same time creating a gateway to access logic that can be created outside the rules, either for enhanced complexity or specific operational requirements (e.g. security).

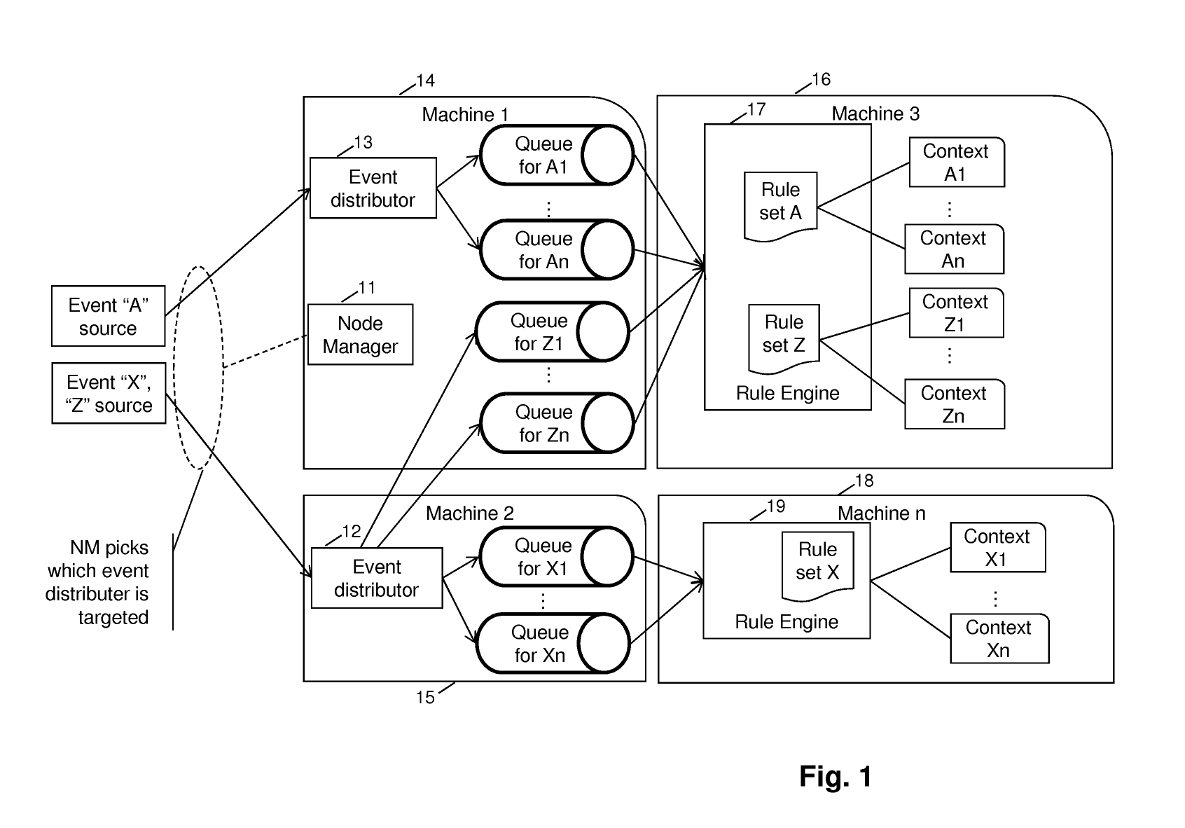

FIG. 1 shows a schematic block diagram illustrating an overall design of a clustered rule engine apparatus according to an embodiment of the invention.

Here different event sources produce related series of events from a certain type; each of these event series can then be associated with a different context. The clustered rule engine apparatus comprises a node manager (node managing unit) 11 which decides which event distributors 12, 13 will process events from which event source. The event distributor 12 is located in a machine 2 (node 15) and processes events of type X and Z. The event distributor 12 inputs event series X1 . . . Xn into queues (context queues) for X1 . . . Xn that are located in the machine 2, and inputs event series Z1 . . . Zn into queues (context queues) for Z1 . . . Zn that are located in a machine 1 (node 14). The event distributor 13 is located in machine 1 and processes events of type A. The event distributor 13 inputs event series A1 . . . An into queues (context queues) for A1 . . . An located in the machine 1.

A machine 3 (node 16) comprises a rule engine (rule engine unit) 17 which receives event inputs from the queues for A1 . . . An and the queues for Z1 . . . Zn. The rule engine 17 comprises a rule set A which is associated with contexts A1 . . . An, and a rule set Z which is associated with contexts Z1 . . . Zn. A machine n (node 18) comprises a rule engine (rule engine unit) 19 which receives event inputs from the queues for X1 . . . Xn, and comprises a rule set X which is associated with contexts X1 . . . Xn.

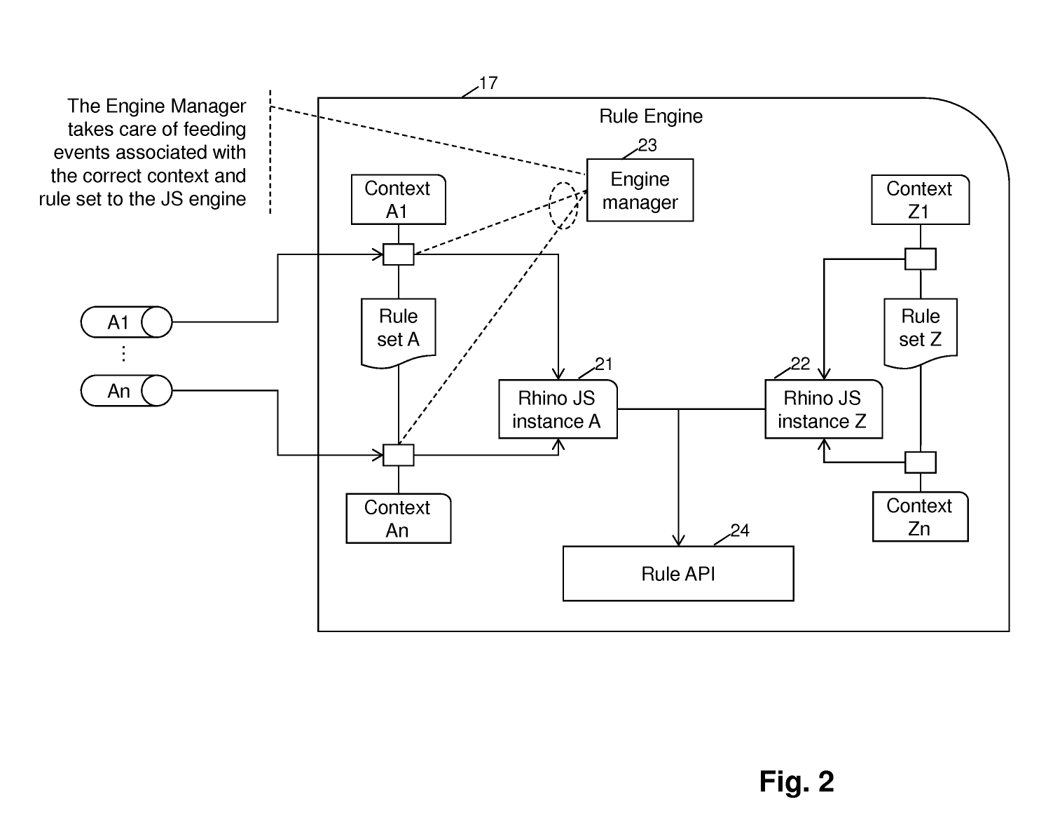

FIG. 2 shows a schematic block diagram illustrating a configuration of a rule engine 17 according to an embodiment of the invention. The rule engine 17 comprises a Rhino JS instance A (JS engine, rule execution unit) 21, a Rhino JS instance Z (JS engine, rule execution unit) 22 and an engine manager (engine managing unit) 23. The JS engine 21 executes rules of the rule set A based on facts of the rule set A corresponding to context A comprising sub-contexts A1 . . . An. The JS engine 22 executes rules of the rule set Z based on facts of the rule set Z corresponding to context Z comprising sub-contexts Z1 . . . Zn.

The engine manager 23 selects, for an event belonging to one of the series A1 . . . An which is input to the rule engine 17 and associated with a rule set A the Rhino JS instance A 21 which is associated with the rule set A. Moreover, the engine manager 23 associates the event of series A1 with a correct (sub-)context A1, and the event An with a correct (sub-) context An. In other words, the engine manager 23 executes control to feed the events of series A1 . . . An associated with the correct (sub-)contexts A1 . . . An and rule set A to the JS engine 21. Thus, in response to each event, the JS engine 21 executes rules of the rule set A based on facts of the rule set A. The JS engine 21 sequentially processes the events from each series A1 . . . An in chronological order of their receipt at the rule engine 17.

According to an embodiment of the invention, the rule engine 17 comprises a rule API (interface unit) 24 which interfaces the rule engine 17 and a backend unit (not shown). The JS engines 21 and 22 use the rule API for accessing resources of the backend unit.

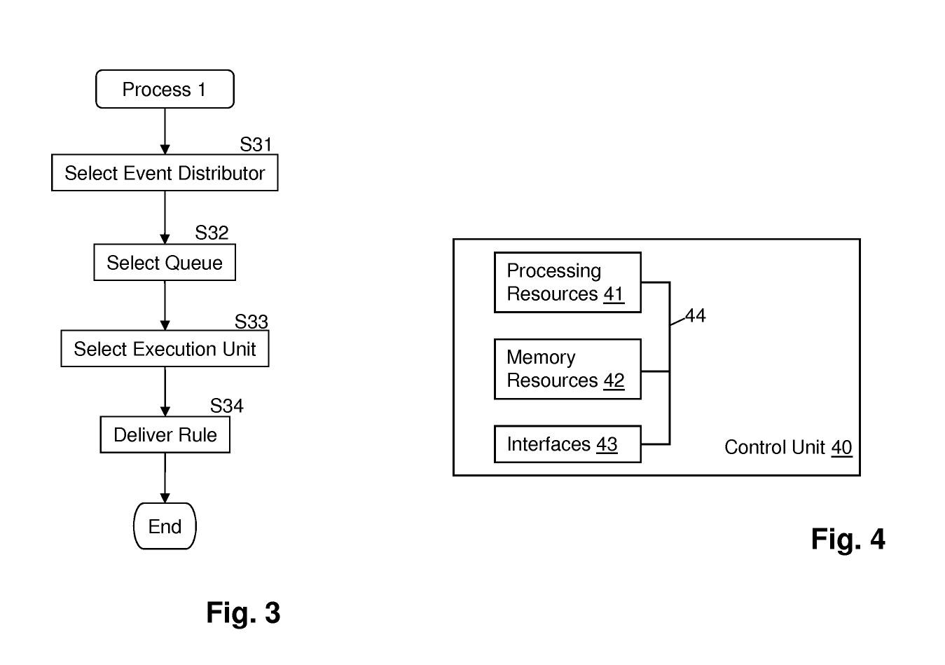

FIG. 3 shows a flow chart illustrating a process 1 according to an embodiment of the invention.

According to an embodiment of the invention, when an event associated with a sub-context of a specific context is input e.g. into the rule engine apparatus as illustrated in FIG. 1, in step S31, the node manager 11 selects an event distributing unit or distributer of a plurality of event distributing units, which distributes events towards queues for the specific context (in FIG. 1, one of A1 . . . An, X1 . . . Xn or Z1 . . . Zn).

In step S32, the selected event distributing unit selects a queue for the sub-context, which is associated with a rule engine of a plurality of rule engines 17, 19, which comprises a rule execution unit, e.g. a JS engine, associated with the specific context.

In step S33, the event in the selected sub-context queue is delivered to an engine manager of the rule engine, which then associates it with the appropriate context and sub-context and rule set (e.g., context A, sub-context A1, rule set A in FIG. 2), and selects the JS engine (Rhino instance 21 in FIG. 2).

In step S34, the engine manager delivers the event, sub-context and rule of the rule set to the selected rule engine instance (e.g., one of instances 21, 22; instance 21 in FIG. 2) for execution.

According to embodiments of the invention as described above, the JS engine serves as a core rule execution unit where the rules will be defined and requests to be executed as new events arrive into the rule engine apparatus shown in FIG. 1. Upon event arrival, a first layer of event processing depicts if each event is meaningful for any rules and, if so, passes the event to be processed by the rule engine execution unit. In the case the event is meaningful for several rules, the initial event is replicated and each copy set to target a specific rule.

The different levels of the JS engine are isolated by JMS queues to ensure full asynchronous behavior and allow more control over parallel execution pipes. The node manager 11 directs the several event sources to send events to dedicated source queues (not shown) attached to event distributors, and the event processing layer (event distributors) sends events to the context queues as shown in FIG. 1. The rule execution units 21, 22 (cf. FIG. 2) are then requested to run specific rules by a consumer of such context queues.

This is possible because the rules and their triggers are modeled, thus allowing the first layer of event processing to find if events are meaningful and for which rules. As opposed to typical Rete implementations, this approach leaves to the rule execution any evaluation of the facts values (note that it has already been asserted that the fact is meaningful for the rule during the first layer of the rule engine). This is good for certain use cases, because the comparison values are variables (or even calculations with variables) that will depend on the context and characteristics of the facts, which will make the Rete nodes complex and eventually slower than the JS execution. Furthermore, rules typically take some action based on a certain event but then do something else if another event follows. According to embodiments of the invention as described above, the logic referent to this dependency is kept within the same rule, which is easier to maintain and considered to be of better usability compared to creating different rules for the different actions. Rules are therefore executed for every defined fact, but the user decides on what parts of logic to run, based on the known facts. The known facts become the rule's responsibility and the decision to store incoming events as facts for later processing, or to remove existing ones, is part of the user defined rule logic.

According to embodiments of the present invention as described above, rule execution schedule and conflict resolution can be skipped as the rules operating at any point are in context of independent events, as enforced by the context queuing of events. This contextual independence allows each rule execution unit to work as fast as possible by making them abstracted to the complexity of other rules. Each rule execution unit manages its own working memory at the same time which leverages the execution unit working memory for context based data (data common to all rules within a certain context). This makes the rules operate with respect to their trigger events with less perceived delay, thereby moving closer to a real-time behavior.

Rules can propagate facts to theirs or other contexts by feeding new events into the rule engine. These events will undergo all the phases of the rule engine (e.g. event processing for rule matching), but they can be set with higher priority than events coming from external sources, to ensure rule chaining or behavior modulation of other rules. So in practice when a rule produces a new event it does not know which rules may have it as a required fact, so it does not explicitly target other rules. Instead this propagation will be derived from the rule definitions and their firing clauses. Again, this brings a lot of independence between rules, both in terms of action code (always similar actions, such as creating new events) and execution (always asynchronous).

The distribution of rules, depending on their context, across different rule engines, allows also to optimize the way the rule engine accesses the knowledge required in that specific context. A working memory of each rule execution unit is created with all the metadata required by its context, so that the processing of events can be done as fast as possible. This is important because typically this metadata information is kept in relatively slow access persistence layers (e.g. relational databases), but since it does not change often, it can be loaded in memory for fast access. Any change in metadata will result in a rule execution unit rebuild (also in case of rules deletion/addition). The rebuild is implemented by creating a new rule execution unit off line and then replace the active one in one shot to reduce the down time to a minimum.

FIG. 4 shows a schematic block diagram illustrating a configuration of a control unit 40 in which examples of embodiments of the invention are implementable. The control unit 40 comprises processing resources 41, memory resources 42 and interfaces 43 which are connected via a link 44. The memory resources 42 store a program and also function as working memory e.g. for the rule execution unit as described above.

The program is assumed to include program instructions that, when executed by the associated processing resources 41, enable the control unit 40 to operate in accordance with the exemplary embodiments of this invention, as detailed above. For example, according to an embodiment of the invention, the control unit 40 operates in accordance with the rule engine 17. According to another embodiment of the invention, the control unit 40 operates in accordance with the node manager 11. According to a further embodiment of the invention, the control unit 40 operates in accordance with the event distributor 12, 13. According to still another embodiment of the invention, the control unit 40 operates in accordance with the engine manager 23. According to a still further embodiment of the invention, the control unit 40 operates in accordance with the rule execution unit 21, 22.

In general, the embodiments of the invention may be implemented by computer software stored in the memory resources 42 and executable by the processing resources 41, or by hardware, or by a combination of software and/or firmware and hardware.

The memory resources 42 may be of any type suitable to the local technical environment and may be implemented using any suitable data storage technology, such as semiconductor-based memory devices, magnetic memory devices and systems, optical memory devices and systems, fixed memory and removable memory. The processing resources may be of any type suitable to the local technical environment, and may include one or more of general purpose computers, special purpose computers, microprocessors, digital signal processors (DSPs) and processors based on a multi-core processor architecture, as non-limiting examples.

According to an embodiment of the invention, a node managing unit selects, for an event associated with a sub-context of a specific context, an event distributing unit of a plurality of event distributing units, which distributes events towards queues for the specific context. The selected event distributing unit selects a queue for the sub-context, which is associated with a rule engine unit of a plurality of rule engines units, which comprises a rule execution unit associated with the specific context. A rule managing unit of the rule engine unit, which receives the event from the selected queue for the sub-context, selects the rule execution unit of the plurality of rule execution units, which is associated with the specific context, and delivers, to the selected rule execution unit, a particular rule of a rule set associated with the rule execution unit, within the associated sub-context.

It is to be understood that the above description is illustrative of the invention and is not to be construed as limiting the invention. Various modifications and applications may occur to those skilled in the art without departing from the true spirit and scope of the invention as defined by the appended claims.

1. A rule engine unit comprising:
a plurality of rule execution units; and
an engine managing unit configured to select, for an event input to the rule engine unit and associated with a rule set of a plurality of rule sets, a rule execution unit of the plurality of rule execution units, which is associated with the rule set,
wherein the rule execution unit selected by the engine managing unit is configured to execute, in response to the event, rules of the rule set based on facts of the rule set.

2. The rule engine unit of claim 1, wherein each rule set corresponds to a specific context, and facts between the plurality of rule sets are independent from each other.

3. The rule engine unit of claim 2, wherein the engine managing unit is configured to associate the event input to the rule engine unit with a sub-context of the specific context.

4. The rule engine unit of claim 1, wherein the plurality of rule execution units each are configured to sequentially process events for which they are selected by the engine managing unit.

5. The rule engine unit of claim 1, comprising:
an interface unit configured to interface the rule engine unit and a backend unit,
wherein each of the plurality of rule execution units are configured to use the interface unit for accessing resources of the backend unit.

6. The rule engine unit of claim 1, wherein the rule execution unit comprises a Rhino Java Script instance.

7. An apparatus comprising:
a plurality of the rule engine units claim 1; and
an event distributing unit configured to select for an event input to the apparatus and associated with a sub-context of a specific context, a queue for the sub-context, which is associated with a rule engine unit of the plurality of rule engines units, which comprises a rule execution unit associated with the specific context.

8. The apparatus of claim 7, comprising:
a plurality of the event distributing units; and
a node managing unit configured to select an event distribution unit of the plurality of event distribution units which distributes events towards queues for the specific context.

9. A method comprising:
selecting, by a node managing unit, for an event associated with a sub-context of a specific context, an event distributing unit of a plurality of event distributing units, which distributes events towards queues for the specific context;
selecting, by the selected event distributing unit, a queue for the sub-context, which is associated with a rule engine unit of a plurality of rule engines units, which comprises a rule execution unit associated with the specific context;
selecting, by a rule managing unit of the rule engine unit, which receives the event from the selected queue for the sub-context, the rule execution unit of the plurality of rule execution units, which is associated with the specific context; and
delivering, by the rule managing unit, to the selected rule execution unit, a particular rule of a rule set associated with the rule execution unit, within the associated sub-context.

10. A computer program product embodied in a non-transitory computer-readable medium, said product including a program for a rule engine apparatus, comprising software code portions for performing the steps of claim 9 when the program is run on the rule engine apparatus.

11. (canceled)

12. The computer program product according to claim 10, wherein the program is directly loadable into an internal memory of the rule engine apparatus.
